(19) United States
(12) Patent Application Publication
(10) Pub. No.: US 2014/0331296 A1
(43) Pub. Date: Nov. 6, 2014

(54) MECHANISM FOR GATEWAY DISCOVERY LAYER-2 MOBILITY

(71) Applicant: QUALCOMM Incorporated, San Diego, CA (US)

(72) Inventor: Stefano Faccin, Hayward, CA (US)

(73) Assignee: QUALCOMM Incorporated, San Diego, CA (US)

(21) Appl. No.: 14/244,190

(22) Filed: Apr. 3, 2014

Related U.S. Application Data
(60) Provisional application No. 61/818,347, filed on May 1, 2013.

(51) Int. Cl. H04W 12/06; H04W 12/08; H04W 36/00

(52) U.S. Cl. CPC H04W 12/06; H04W 36/0038; H04W 12/08
USPC 726/6; 370/331

(57) ABSTRACT

A systems and method for gateway discovery and Layer-2 mobility is operable by an access terminal that connects to an access point. The access terminal determines security credentials and addressing and routing configurations used previously. The access terminal determines whether the security credentials may be reused by the access terminal to perform authentication with an access network and also determines whether the addressing and routing configurations may be reused by the access terminal. In a related system and method, a network entity receives an inquiry from an access terminal regarding whether a prior Trusted Wireless Access Gateway (TWAG) is reusable by the access terminal as a current TWAG. The network entity determines whether the prior TWAG is reusable and may send response to the access terminal indicating whether the prior TWAG is reusable.

### CROSS-REFERENCE TO RELATED APPLICATIONS

This application claims the benefit of U.S. Provisional Patent Application Ser. No. 61/818,347 entitled “MECHANISM FOR GATEWAY DISCOVERY AND LAYER 2 MOBILITY IN WLAN NETWORKS CONNECTED TO AN EPC”, which was filed May 1, 2013. The aforementioned application is herein incorporated by reference in its entirety.

### BACKGROUND

1. Field

Aspects of the present disclosure relate generally to wireless communication systems, and more particularly to techniques for gateway discovery,

2. Background

This application is directed to wireless communications systems, and more particularly to methods and apparatuses for gateway discovery and Layer-2 mobility.

A wireless network may he deployed over a defined geographical area to provide various types of services (e.g., voice, data, multimedia services, etc.) to users within that geographical area. The wireless communication network may include a number of base stations that can support communication for a number of user equipments (UEs). A UE may communicate with a base station via the downlink and uplink.

The 3rd Generation Partnership Project (3GPP) Long Term Evolution (LTE) advanced cellular technology is an evolution of Global System for Mobile communications (GSM) and Universal Mobile Telecommunications System (MTS). The LTE physical layer (PHY) provides a highly efficient way to convey both data and control information between base stations, such as an evolved Node Bs (eNBs), and mobile entities, such as UEs, in prior applications, a method for facilitating high bandwidth communication for multimedia has been single frequency network (SFN) operation. SFNs utilize radio transmitters, such as, for example, eNBs, to communicate with subscriber UEs.

In a trusted Wireless Local Area Network (WLAN) connected to an Evolved Packet Core (EPC) network, a plurality of Trusted Wireless Access Gateways (TWAG) may serve a plurality of access points. UEs sending signaling messages to a TWAG may need to discover the address of the TWAG. When a UE moves between different access points, a TWAG serving the UE may have changed. Unlike device mobility in 3GPP networks, there may be no explicit TWAG relocation through explicit signaling. It may be beneficial to minimize the impact of the UE moving between different access points which may trigger service by different TWAGs.

### SUMMARY

The following presents a simplified summary of one or more examples in order to provide a basic understanding of such examples. This summary is not an extensive overview of all contemplated examples, and is intended to neither identify key or critical elements of all examples nor delineate the scope of any or all examples. Its sole purpose is to present some concepts of one or more examples in a simplified form as a prelude to the more detailed description that is presented later.

In accordance with one or more aspects of the examples described herein, there is provided a system and method for gateway discovery and Layer-2 mobility. In one example aspect, an access terminal may connect to an access point and determine security credentials and addressing and routing configurations used previously. The access terminal may determine whether the security credentials may be reused by the access terminal to perform authentication with an access network. The access terminal may also determine whether the addressing and routing configurations may be reused by the access terminal.

In a second example aspect a network entity may receive an inquiry from an access terminal regarding whether a prior Trusted Wireless Access Gateway (TWAG) is reusable by the access terminal as a current TWAG. The network entity may determine whether the prior TWAG is reusable and may send response to the access terminal indicating whether the prior TWAG is reusable.

### BRIEF DESCRIPTION OF THE DRAWINGS

FIG. 1 is a block diagram conceptually illustrating an example of a telecommunications system;

FIG. 2 is a block diagram conceptually illustrating an example of a down link frame structure in a telecommunications system;

FIG. 3 is a block diagram conceptually illustrating an example design of a base station and a UE;

FIG. 4 illustrates an exemplary non-roaming reference model for a trusted non-3GPP WLAN access;

FIG. 5 illustrates an exemplary roaming reference model for a trusted non-3GPP WLAN access;

FIG. 6 is a call flow diagram illustrating an exemplary process of EAP authentication in a trusted WLAN;

FIG. 7 is a call flow diagram illustrating an exemplary process of UE initiated connectivity in a trusted WLAN;

FIG. 8 illustrates aspects of an example methodology for gateway discovery and Layer-2 mobility;

FIG. 9 shows an implementation of an apparatus (e.g., a mobile device or the like) for gateway discovery and Layer-2 mobility, in accordance with the methodology of FIG. 8;

FIG. 10 illustrates aspects of another example methodology for gateway discovery and Layer-2 mobility; and

FIG. 11 shows another implementation of an apparatus (e.g., a network entity or the like) for gateway discovery and Layer-2 mobility, in accordance with the methodology of FIG. 10.

### DETAILED DESCRIPTION

Techniques for gateway discovery and Layer-2 mobility are described herein. In a trusted Wireless Local Area Network (WLAN) connected to an Evolved Packet Core (EPC) network, a plurality of Trusted Wireless Access Gateways (TWAG) may serve a plurality of access points. UEs sending signaling messages to a TWAG may need to discover the address of the TWAG. When a LTE moves between different access points, a TWAG serving the UE may have changed. The UE may need to discover whether the same TWAG is serving the UE. The subject disclosure provides a technique for optimizing the user equipment (LTE) moving between the different access points.

In the subject disclosure, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The techniques may be used for various wireless communication networks such as wireless wide area networks (WWANs) and wireless local area networks (WLANs). The terms “network” and “system” are often used interchangeably. The WWANs may be code division multiple access (CDMA), time division multiple access (TDMA), frequency division multiple access (FDMA), orthogonal frequency-division multiple access (OFDMA), single carrier frequency division multiple access (SC-FDMA) and/or other networks. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.16 (WiMAX), IEEE 802.20, Flash-OFDM®, etc, UTRA and E-UTRA are part of Universal Mobile Telecommunication System (UMTS). 3GPP Long Term Evolution (LTE) and LTE-Advanced (LTE-A) are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). A WLAN may implement a radio technology such as IEEE 802.11 (Wi-Fi), Hiperlan, etc.

As used herein, the downlink (or forward link) refers to the communication link from the base station to the UE, and the uplink (or reverse link) refers to the communication link from the UE to the base station. A base station may be, or may include, a macrocell or microcell. Microcells picocells, ferutocells, home nodeBs, small cells, and small cell base stations) are characterized by having generally much lower transmit power than macrocells, and may often be deployed without central planning. In contrast, macrocells are typically installed at fixed locations as part of a planed network infrastructure, and cover relatively large areas

The techniques described herein may he used for the wireless networks and radio technologies mentioned above as well as other wireless networks and radio technologies. For clarity, certain aspects of the techniques are described below for 3GPP network and WLAN, and LTE and WLAN terminology is used in much of the description below.

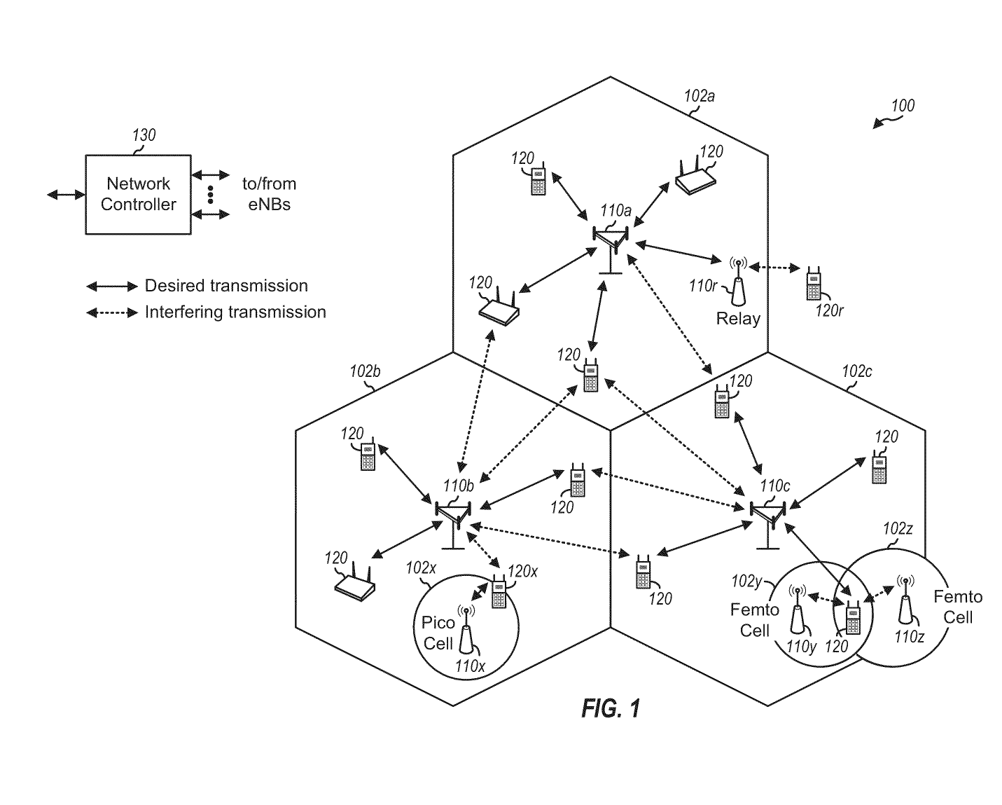

FIG. 1 shows a wireless communication network 100, which may be a LTE network. The wireless network 100 may include a number of eNBs 110 and other network entities. An eNB may be a station that communicates with the UEs and may also be referred to as a base station, a Node B, an access point, or other term. Each eNB 110a, 110b, 110c may provide communication coverage for a particular geographic area. In 3GPP, the term “cell” may refer to a coverage area of an eNB and/or an eNB subsystem serving this coverage area, depending on the context in which the term is used.

An eNB may provide communication coverage for a macro cell, a pico cell, a tenth.) cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in. a Closed Subscriber Group (CSG), UEs for users in the home, etc.). An eNB for a macro cell may be referred to as a macro eNB. An eNB for a pico cell may he referred to as a pico eNB. An eNB for a femto cell may be referred to as a femto eNB or a home eNB (IINB). In the example shown in FIG. 1, the eNBs 110a, 110b and 110c may be macro eNBs for the macro cells 102a, 102b and 102c, respectively. The eNB 110x may be a pico eNB for a pico cell 102x. The eNBs 110y and 110z may be femto eNBs for the funto cells 102y and 102z, respectively. An eNB may support one or multiple (e.g., three) cells.

The wireless network 100 may also include relay stations 110r. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 Watts) whereas pico eNBs, femto eNBs and relays may have a lower transmit power level (e.g., 1 Watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not he aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A LTE may also be referred to as an access terminal, a mobile device, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WL) station, or other mobile entities. A UE may be able to communicate with macro eNBs, pico eNBs, femto eNBs, relays, or other network entities. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2044 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

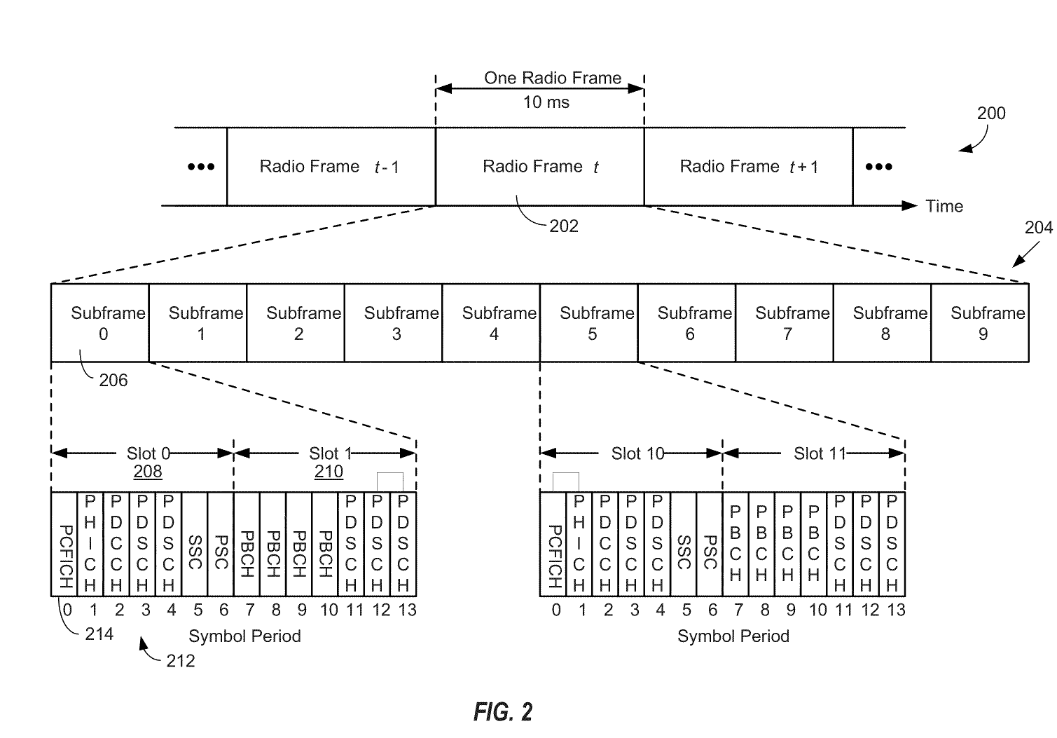

FIG. 2 shows a down link frame structure used in LTE. The transmission timeline for the downlink may be partitioned into units of radio frames 200. Each radio frame, for example, frame 202, may have a predetermined duration (e.g., 10 milliseconds (ms)) and may be partitioned into 10 subframes 204 with indices of 0 through 9. Each subframe, for example ‘Subframe 0’ 206, may include two slots, for example, ‘Slot 0’ 208 and ‘Slot 1’ 210. Each radio frame may thus include 20 slots with indices of 0 through 19. Each slot may include ‘L’ symbol periods, e.g., 7 symbol periods 212 for a normal cyclic prefix (CP), as shown in FIG. 2, or 6 symbol periods for an extended cyclic prefix. The normal CP and extended CP may be referred to herein as different CP types. The 2L symbol periods in each subframe may be assigned indices of 0 through 2L-1. The available time frequency resources may be partitioned into resource blocks. Each resource block may cover ‘N’ subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in only a portion of the first symbol period of each subframe, although depicted in the entire first symbol period 214 in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical H-ARQ indicator Channel (PHICH) and a Physical Downlink Control Channel (PDCCH) in the first M symbol periods of each subframe (M=3 in FIG. 2). The PHICH may carry information to support hybrid automatic repeat request (H-ARQ). The PDCCH may carry information on resource allocation for UEs and control information for downlink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available,

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCII in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more confierurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCII. The number of combinations to search is typically less than the number of allowed combinations for the PDCCH. An eNB may send the PDCCH to the UE in any of the combinations that the LTE will search.

A LTE may be within the coverage of multiple eNBs. One of these eNBs may be selected to serve the UE. The serving eNB may be selected based on various criteria such as received power, path loss, signal-to-noise ratio (SNR), etc.

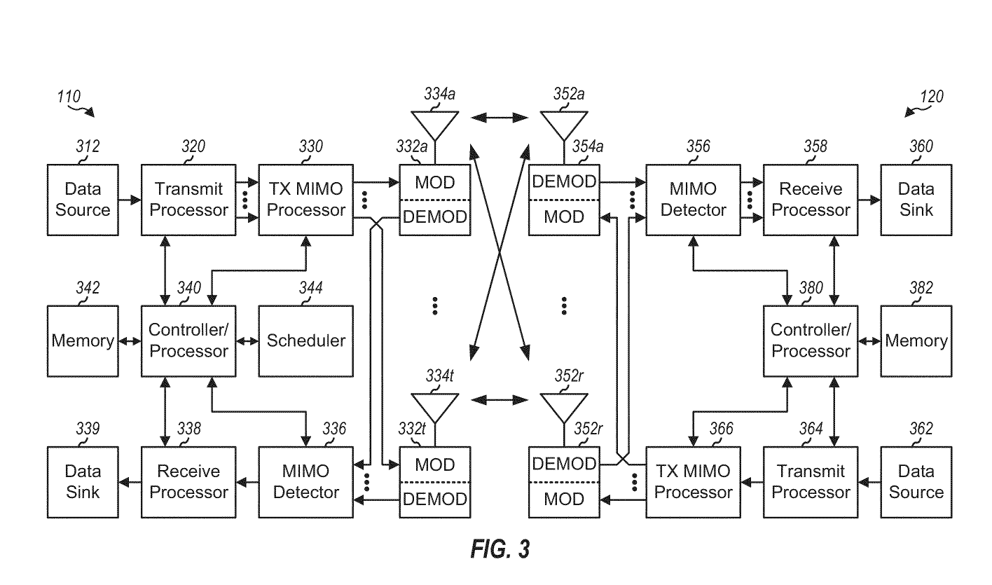

FIG. 3 shows a block diagram of a design of a base station/eNB 110 and a UE 120, which may be one of the base stations/eNBs and one of the UEs in FIG. 1. The base station 110 may also be a base station of some other type. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PERCH, PDCCH, etc. The data may be for the PDSCH, etc. The processor 320 may process (e.g., encode and symbol map) the data and control information to obtain data symbols and control symbols, respectively. The processor 320 may also generate reference symbols, e,g., for the PSS, SSS, and cell-specific reference signal, A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal, Downlink signals from modulators 332a through 332t may be transmitted via the antennas 334a through 334t, respectively.

At the LTE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols, A MIMO detector 356 may obtain received symbols from all the demodulators 354a through 354r perform MIMO detection on the received symbols if applicable, and provide detected symbols. A receive processor 358 may process (e.g., demodulate, deterleave, and decode) the detected symbols, provide decoded data for the UE 120 to a data sink 360, and provide decoded control information to a controller/processor 380. The processor 380 may include modules for performing operations of the methods described herein, by executing instructions held in the memory 382. Such modules may include, for example, modules for measuring data quality, sensing resource constraints, and providing control signals in a control channel for transmitting to the eNB 110.

On the uplink, at the LTE 120, a transmit processor 364 may receive and process data (e.g., for the Physical Uplink Shared Channel (PUSCH)) from a data source 362 and control inforniation (e,g., for the Physical Uplink Control Channel (PUCCII)) from the controller/processor 380. The processor 364 may also generate reference symbols for a reference signal. The symbols from the transmit processor 364 may be precoded by a TX MIMO processor 366 if applicable, further processed by the modulators 354a through 354r (e.g., for SC-FOM, etc.), and transmitted to the base station 110. At the base station 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

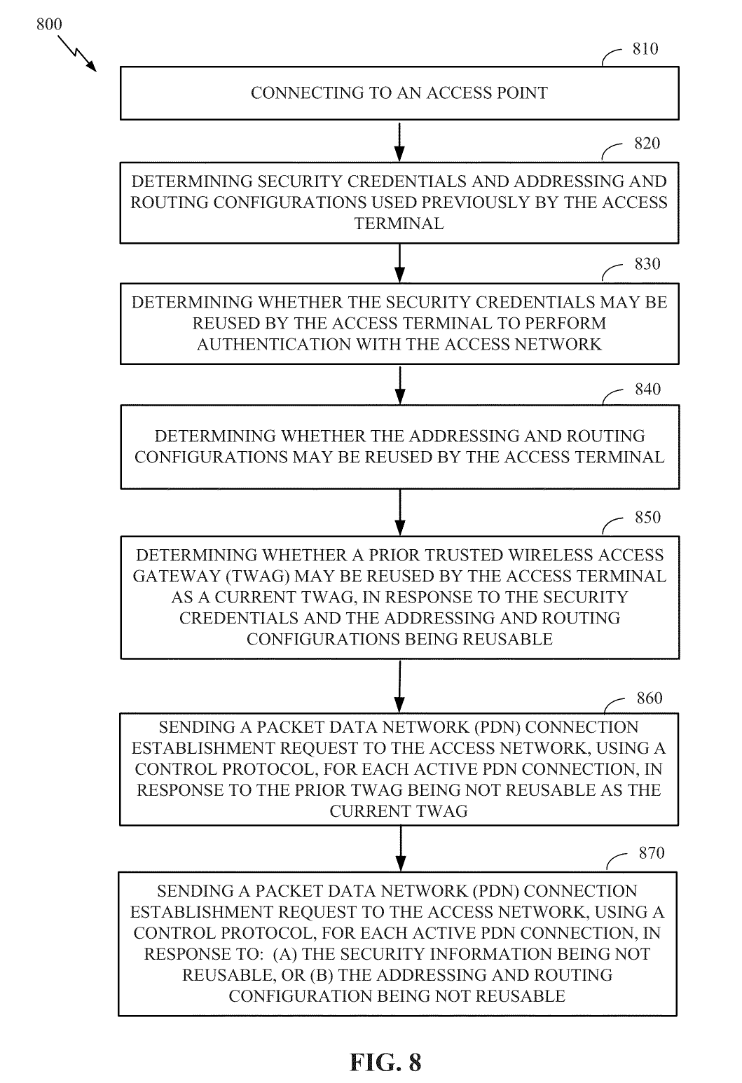

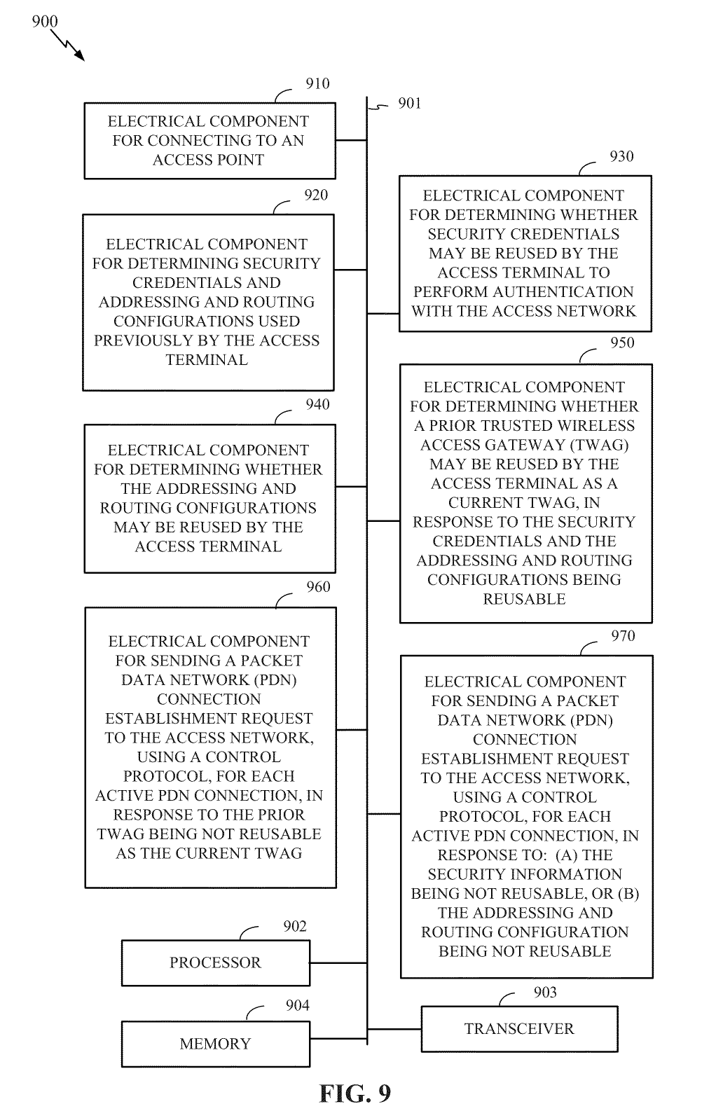

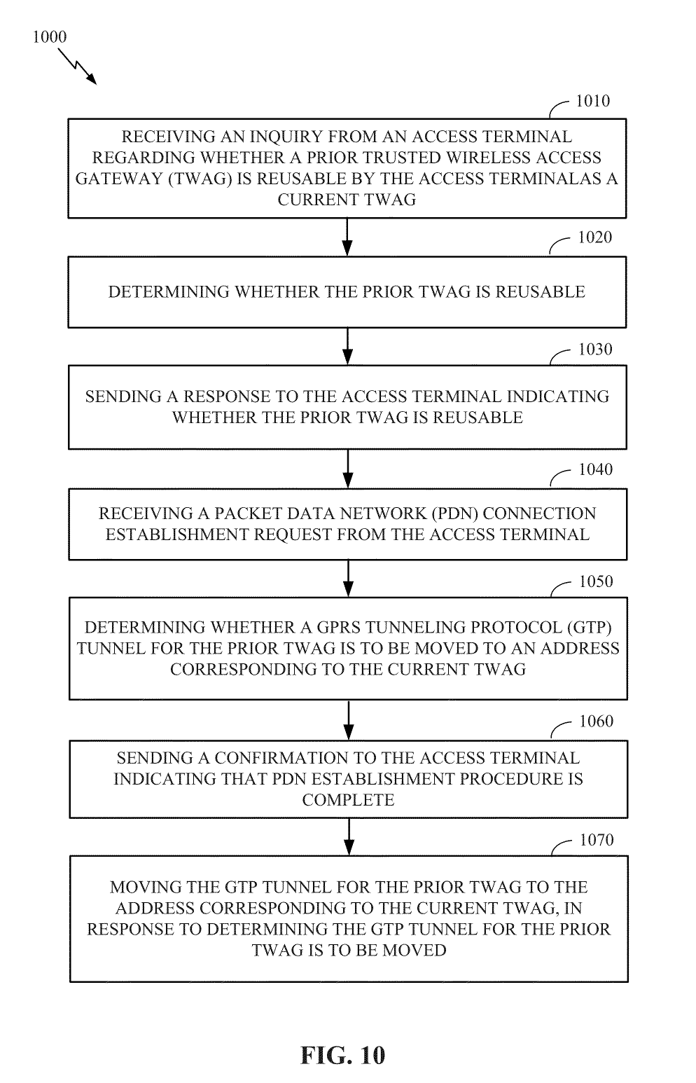

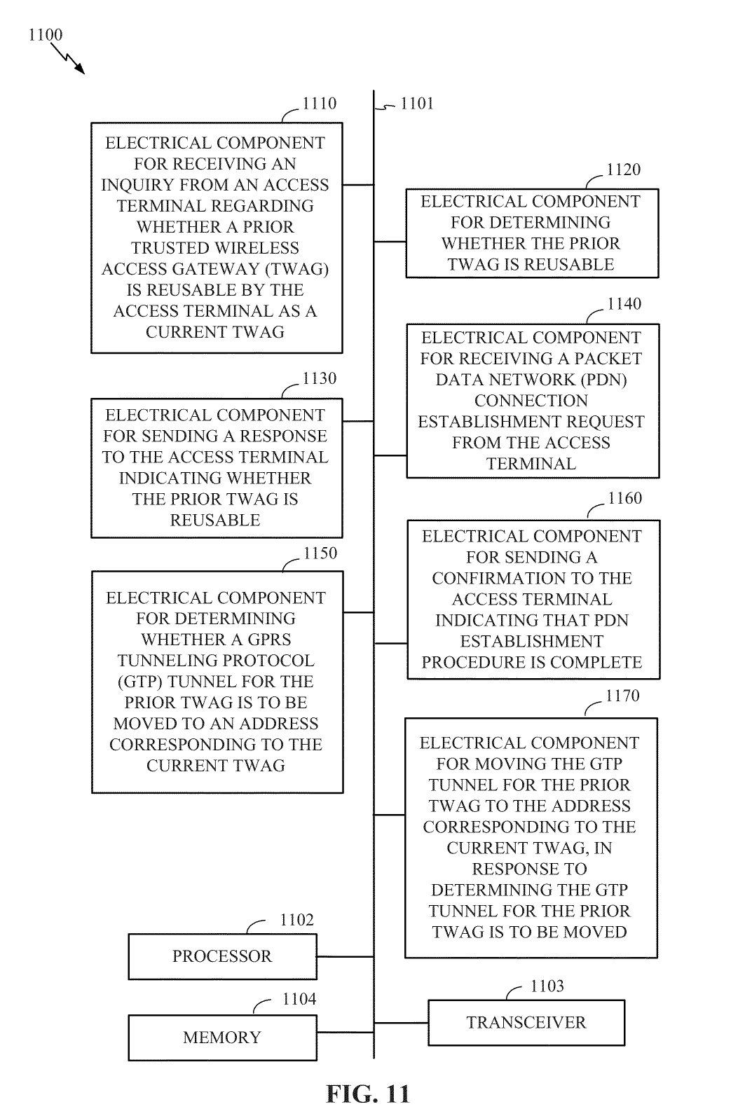

The controllers/processors 340 and 380 may direct the operation at the base station 110 and the UE 120, respectively. For example, the processor 380 and/or other processors and modules at the UE 120 may perform or direct the execution of the blocks illustrated in FIG. 8 and/or other processes for the techniques described herein. The UE 120 may include one or more of the components as shown and described in connection with FIG. 9. Likewise, the processor 340 and/or other processors and modules at the base station 110 may perform or direct the execution of the blocks illustrated in FIG. 10 and/or other processes for the techniques described herein. The base station 110 may include one or more of the components as shown and described in connection with FIG. 11. The memories 342 and 382 may store data and program codes for the base station 110 and the UE 120, respectively. A scheduler 344 may schedule UEs for data transmission on the downlink and/or uplink.

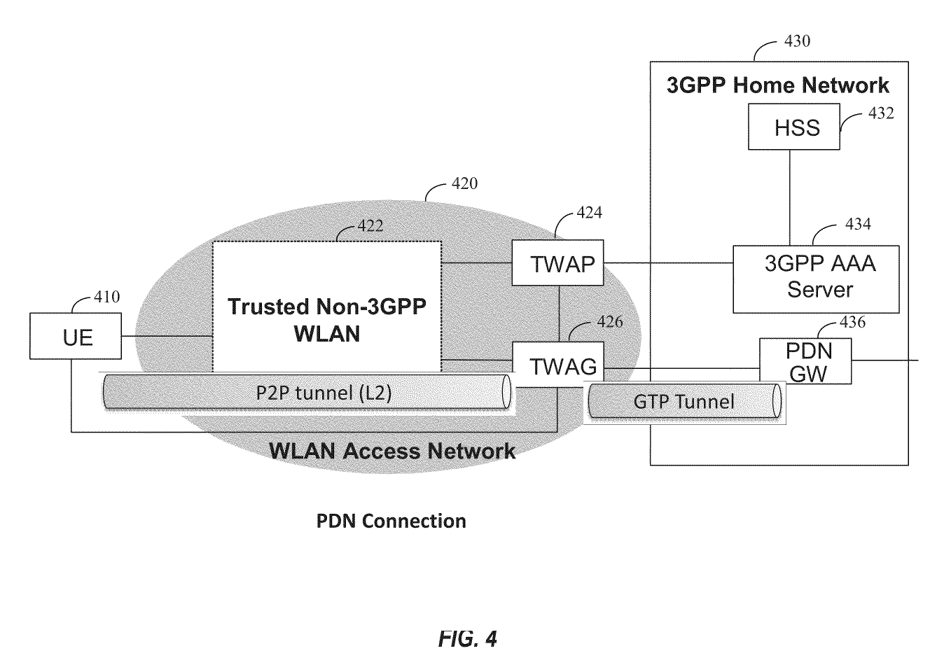

FIG. 4 illustrates an exemplary architecture for trusted non-3GPP Wireless Local Area Network (WLAN) access in a non-roaming wireless communication network. A UE 410 may establish a Packet Data Network (PDN) connection by connecting to a 3GPP Home Network 430 through a WLAN access network 420. The WLAN access network 420 may include a Trusted WLAN Access Gateway (TWAG) 426 and a Trusted WLAN AAA Proxy (TWAP) 424. The 3GPP Home Network 430 may include a Home Subscriber Server (HSS) 432, a 3GPP Authentication Authorization and Accounting (AAA) server 434, and a PDN Gateway (PDN-GW) 436.

The TWAG 426 may act as a router and enforces routing of packets between a UE Media Access Control (MAC) address and a CPRS Tunneling Protocol (GTP) tunnel for the UE, and may enforce per-UE Layer-2 (L2) encapsulation of traffic to and from the UE 410. The TWAG 426 may connect to the LTE 410 via a P2P tunnel in L2 and to the PDN-GW 436 via a GTP tunnel.

The TWAP 424 may relay AAA information between a WLAN 422 and a 3GPP AAA server 434 (or proxy in case of roaming). The TWAP 424 may establish binding of a LTE International Mobile Subscriber Identity (IMSI) with the UE MAC address on the WLAN access network 420 by snooping on the AAA protocol carrying Extensible Authentication Protocol-Authentication and Key Agreement (EAP-ATMA) exchange. The TWAP 424 may detect a L2 attach of the UE 410 to the WLAN access network 420 via snooping on the AAA protocol for an EAP-Success message, and informs the TWAG 426 of WLAN attach and detach events for the UE 410.

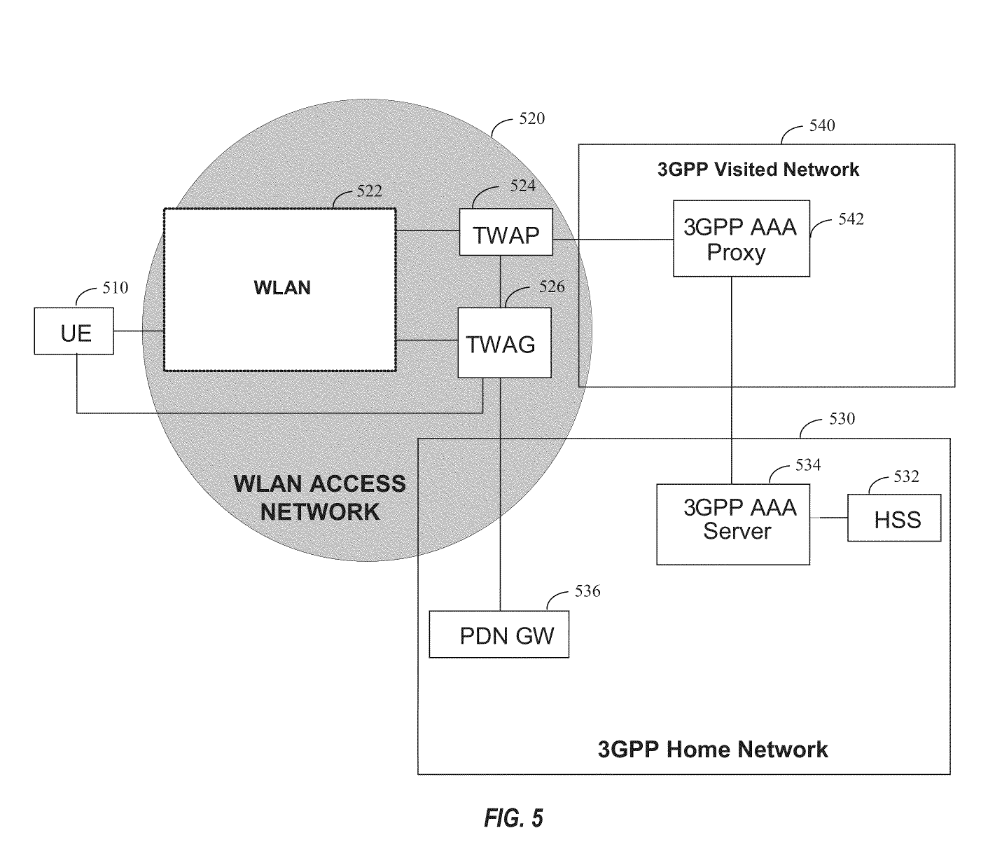

FIG. 5 illustrates an exemplary architecture for trusted non-3GPP WLAN access in a roaming wireless communication network. In comparison to the exemplary architecture for a trusted non-3GPP WLAN access network in a non-roaming wireless communication network of FIG. 4, the roaming architecture of FIG. 5 may further include a 3GPP Visited Network 450. The 3GPP Visited Network 540 may include a 3GPP AAA Proxy 542. The TWAP 524 may be routed through a 3GPP AAA Proxy 542 to a 3GPP AAA Server 534 in the architecture of FIG. 5.

A UE in an IEEE 802.11 (WLAN) network may make its own decisions on when to handoff and to which access point it wishes to handoff to. IEEE 802.11r may specify fast Basic Service Set (BSS) transitions between access points by redefining a security key negotiation protocol, allowing negotiations and requests for wireless resources to occur in parallel, IEEE 802.11i may specify for 802.1X-based authentications for a client to renegotiate a key, with a Remote Authentication Dial In User Service (RADIUS) or another authentication server that supports an Extensible Authentication Protocol (EAP) or the like, for each handoff, a time consuming process, IEEE 802.11r may allow for the part of the key derived from the server to be cached in the wireless network, so that a number of future connections can be based on the cached key, thereby avoiding the 802.1X process.

In an example method for gateway discovery and L2 mobility, a UE to TWAG protocol may be used to setup and teardown a per-PDN point-to-point link. A control protocol, such as, for example, a WLAN Control Protocol (WLCP) or other similar/appropriate protocol(s), may be selected as the UE to TWAG protocol. The control protocol may be defined by 3GPP, and may be transported above the L2 layer and below the IP Layer. The control protocol may provide session management functionality for PDN connections, such as, for example: (a) establishment of PDN connections; (h) handover of PDN connections; (c) request of the release of PDN connections by the UE; (d) notification of the UE of the release of a PDN connection; (e) IP address assignment such as IPv4 and IPv6 address assignment mechanisms defined for a Non-Access Stratum (NAS); and/or (f) PDN parameters management such as Access Point Name (APN), PDN type, address, Protocol Configuration Options (PCO), request type, L2 transport identifier, and/or the like. The control protocol applies to support multiple PDN connections and enables behavior similar to UE behavior over cellular link. The control protocol may be a protocol running between the UE and the TWAG, such that the intermediate nodes, such as access points between the LTE and the TWAG, do not need to support the control protocol.

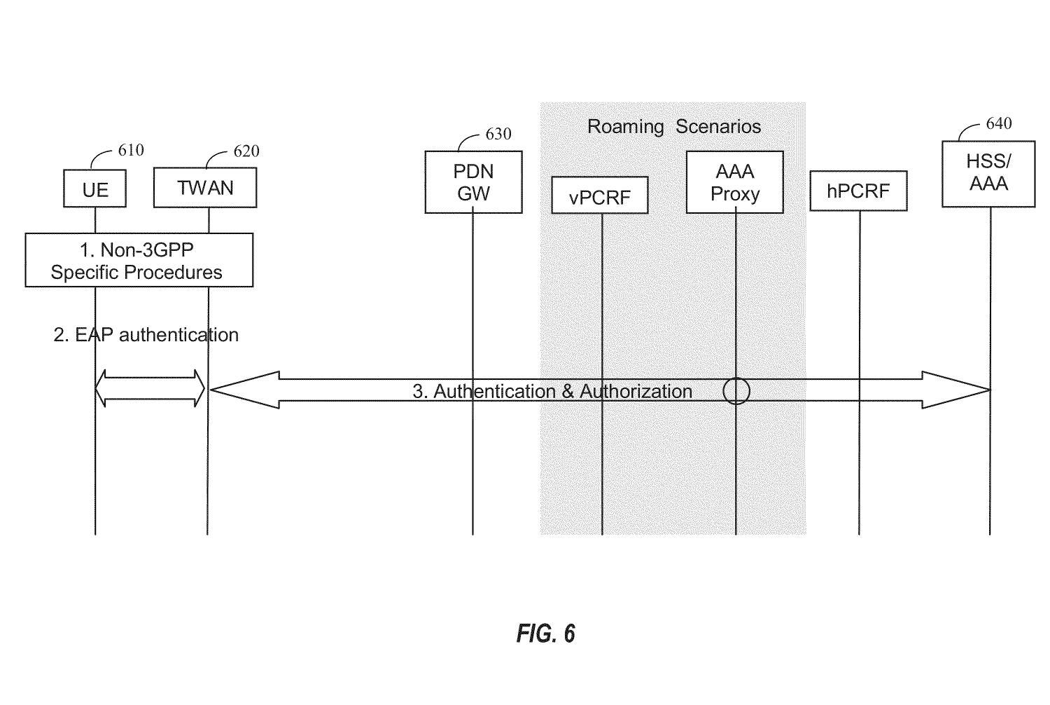

FIG. 6 is a call flow diagram illustrating an exemplary process of EAP authentication. in a trusted WLAN or the like. The UE, the Trusted WLAN Access, and the 3GPP AAA Server in the Home Public Land Mobile Network (HPLMN) may determine whether they all support Trusted WLAN Access to the Evolved Packet Core (EPC).

Referring to FIG. 6, in step 1, the UE 610 may discover a Trusted WLAN Access Network (TWAN) 620 and may associate with the TWAN 620. This step may include non-3GPP specific procedures. In step 2, the TWAN 620 may authenticate with the UE 610. In step 3, the TWAN 620 may conduct authentication and authorization with a HSS/AAA server 640. The TWAN 620 may begin an EAP exchange by sending an EAP Request message as part of an IEEE 802.1X authentication procedure or the like. As part of the EAP exchange, the UE 610, the TWAN 620, and/or the 3GPP AAA Server 640 in the HPLMN may discover whether they support Trusted WLAN Access to the EPC (i.e., whether they support concurrent multiple PDN connections, IP address preservation, and concurrent Non-Seamless WLAN Offload and EPC access). If the UE 610, the TWAN 620, and the HPMEN all support trusted WLAN access to the EPC, PDN connections and Non-Seamless WLAN Offload (NSWO) may not be offered automatically by the TWAN 620 without explicit request from the UE 610.

UE initiated connectivity may be used when a UE 610 has previously attached to a WLAN and the UE 610 attempts to establish one or more PDN connections over the WLAN. This procedure may also used when the UE 610 already has one or more PDN connections over the WLAN and wishes to establish one or more additional PDN connections over WLAN. This procedure may further he used to request connectivity to an additional PDN connection over the WLAN when the UE 610 is simultaneously connected to the WLAN and a 3GPP access network, and the UE 610 already has active PDN connections over both the accesses. The UE 610 may establish a separate point-to-point link to the TWAG for each PDN connection.

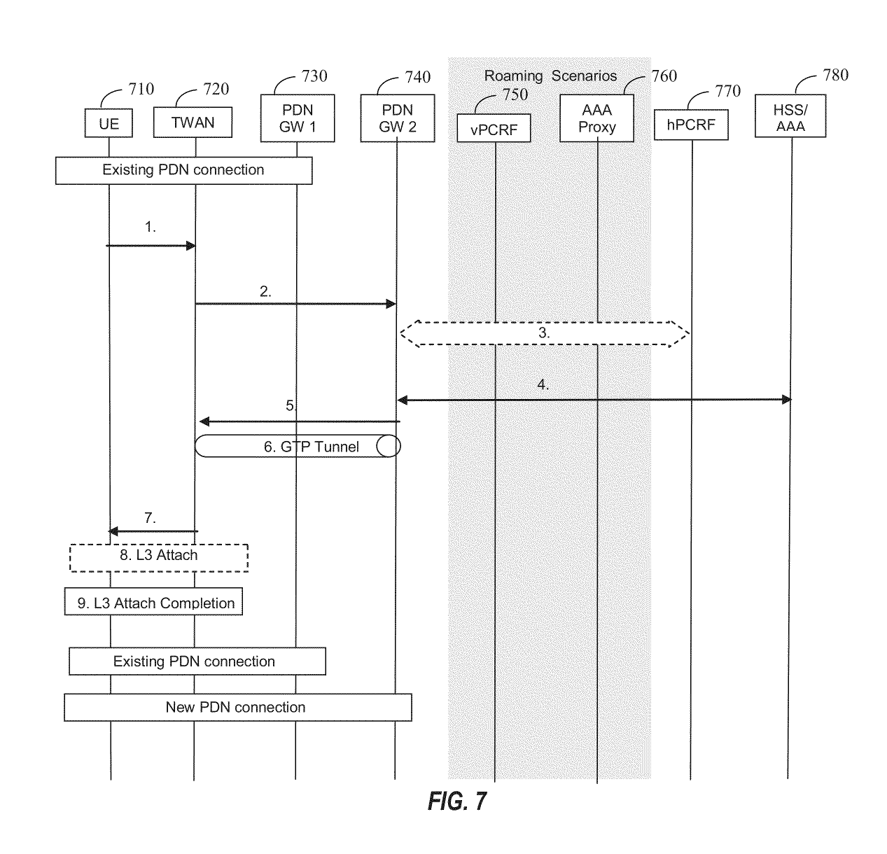

FIG. 7 is a call flow diagram illustrating an exemplary process for UE initiated connectivity in a WLAN or the like. A UE 710 may have an existing PDN connection to a first PDN-GW (PDN-GW1) 730 and wishes to establish a new PDN connection to a second PDN-GW (PDN-GW2) 740. In step 1, the UE 710 may trigger the establishment of a new per-UE-and-PDN point-to-point link by utilizing a control protocol, such as, for example, WLCP or the like. This may set up a new per-UE-and-PDN-connection point-to-point link with a TWAG. The UE 710 may indicate an APN or the like. The UE 710 may trigger the re-establishment of an existing PDN connectivity by providing a handover indicator. In steps 2-6, the TWAN 720 may perform PDN-GW selection to establish PDN-GW2 710 from PDN-GW1 730. In step 2, the TWAN 720 may send a create session request to PDN-GW2 730. In a roaming scenario, steps 3 and 4 may be applied. In step 3, a visiting Policy Charging and Rules Function (hPCRE) 750 may conduct an IP Connectivity Access Network (IP-CAN) session establishment procedure with a home PCRF (hPCRE) 770. In step 4, the PDN-GW2 740 may update a PDN-GW address with a HSS/AAA server 780. In step 5, the PDN-GW2 740 may send a create session response back to the TWAN 720. In step 6, a GTP tunnel may be established between the TWAN 720 and the PDN-GW2 710. In step 7, by using the control protocol, the TWAN 720 may return a response to the establishment of a new per-UE-and-PDN point-to-point link, If the LIE 710 did not indicate an APN in the request, then the response may indicate the selected default APN. In step 8, if the UE does not receive an IPv4 address in this step, the UE 710 may negotiate the IPv4 address with Dynamic Host Configuration Protocol version 4 (DHCPv4),

In a trusted Wireless Local Area Network (WLAN) connected to an Evolved Packet Core (EPC) network, a plurality of Trusted Wireless Access Gateways (TWAG) may serve a plurality of access points. UEs sending signaling messages to a TWAG may need to discover the address of the TWAG. When a UE moves between different access points, a TWAG serving the UE may have changed. Unlike device mobility in 3GPP networks, there may be no explicit TWAG relocation through explicit signaling. Techniques may be used for the UE to discovering whether the same TWAG is serving the UE.

It may be beneficial to minimize the impact of a UE moving between different access points which may trigger service by different TWAGs. Specifically, it may be beneficial to ensure that a change of TWAG does not require the TIE to re-authenticate with the new TWAG. For example, if the UE obtains or discovers the address of the TWAG upon successful EAP authentication, a change of TWAG may require the LSE to re-authenticate with the new TWAG in order to obtain the new TWAG address. The re-authenticate process may be time and resource consuming.

A known solution for the UE to discover the address of the TWAG may be to have the TWAG provide to the LIE, upon successful EAP authentication, the TWAG MAC address that the device shall use to exchange signaling with the TWAG. This solution may not always be used. In some possible deployments, the network entity authenticating the device may have no connection with the TWAG during authentication. In some cases, the UE may only contact the authentication entity after authentication (e.g., by sending a DHCPv4 request to the TWAG). In some cases, the TWAG MAC may not be known to the authentication entity (e.g., TWAP) during authentication. The TWAG may find the TWAP based on a pre-configuration (e.g., all access lines x-y are served by TWAP z).

A second known solution for the UE to discover the address of the TWAG may be to send a first signaling message to the TWAG (e.g., a request to establish a PDN connection) using a broadcast address for the TWAG. Upon receiving such request, the TWAG (or another available TWAG) may reply to the UE upon completion of the procedure. The UE may use and store the address of the TWAG that sends the reply for future signaling messages.

A third known solution for the UE to discover the address of the TWAG may be to send a request to the network behind the access point (e.g., using a new L2 protocol and sending the message in a broadcast) requesting the address of the TWAG to be used. Upon receiving the request, the network (e.g., one of the TWAGs) may return an indication to the UE containing the address of the TWAG.

In accordance with one or more aspects of the implementations described herein, with reference to FIG. 8, there is shown an example methodology 800 for gateway discovery and L2 mobility, operable by an access terminal. The method 800 may involve, at 810, connecting to an access point. In an example aspect, connecting to the access point refers to handing over to the access point from another access point. In some implementations, the access point is for a WLAN.

The method 800 may involve, at 820, determining security credentials (e.g., encryption and authentication keys) and addressing and routing configurations used previously by the access terminal. In an example aspect, the security credentials include encryption or authentication keys or other such credentials.

The method 800 may involve, at 830, determining whether the security credentials may be reused by the access terminal to perform authentication with the access network. In an example aspect, the access network includes the current TWAG. In some implementations, the access network is connected to an EPC,

The method 800 may involve, at 840, determining whether the addressing and routing configurations may be reused by the access terminal. In an example aspect, determining whether the addressing and routing configurations may be reused includes using a DNA procedure.

With continued reference to FIG. 8, there are also shown further operations or aspects that are optional and may be performed by a mobile device or component(s) thereof. The method 800 may terminate after any of the shown blocks without necessarily having to include any subsequent downstream block(s) that may be illustrated, it is further noted that numbers of the blocks do not imply a particular order in which the blocks may be performed according to the method 800.

The method 800 may optionally involve, at 850, determining whether a prior Trusted Wireless Access Gateway (TWAG) may be reused by the access terminal as a current TWAG, in response to the security credentials and the addressing and routing configurations being reusable. If the prior TWAG is reusable, then further steps may not be required, in an example aspect, determining whether the prior TWAG may be reused includes sending an inquiry to the access network. The inquiry may, for example, include an address of the current TWAG. In sonic implementations, the inquiry may be sent through a broadcast Layer-2 access.

The method 800 may optionally involve, at 860, sending a Packet Data Network (PDN) connection establishment request to the access network, using a control protocol, for each active PDN connection, in response to the prior TWAG being not reusable as the current TWAG. In an example aspect, the PDN connection establishment request includes a handover indication which indicates that the request is not for a new PDN connection. In an example aspect, the PDN connection establishment request includes a handover indication which indicates that the request is not for a new PDN connection.

The method 800 may optionally involve, at 870, comprising sending a Packet Data Network (PDN) connection establishment request to the access network, using a control protocol, for each active PDN connection, in response to: (a) the security information being not reusable, or (b) the addressing and routing configuration being not reusable,

In accordance with one or more aspects of the implementations described herein, FIG. 9 is a block diagram of an example apparatus 900 for gateway discovery and L2 mobility. The exemplary apparatus 900 may be configured as a mobile computing device or as a processor or similar device/component for use within. In one example, the apparatus 900 may include functional blocks that can represent functions implemented by a processor, software, or combination thereof (e.g., firmware). In another example, the apparatus 900 may be a system on a chip (SoC) or similar integrated circuit (IC).

In one implementation, apparatus 900 may include an electrical component or module 910 for connecting to an access point. The apparatus 900 may include an electrical component 920 for determining security credentials and addressing and routing configurations used previously. The apparatus 900 may include an electrical component 930 for determining whether security credentials may be reused by the access terminal to perform authentication with the access network. The apparatus 900 may include an electrical component 940 for determining whether addressing and routing configurations may be reused by the access terminal.

In further related aspects, the apparatus 900 may optionally include an electrical component 950 for detel wining whether a prior Trusted Wireless Access Gateway (TWAG) may be reused by the access terminal as a current TWAG, in response to the security credentials and the addressing and routing configurations being reusable. The apparatus 900 may optionally include an electrical component 960 for sending a Packet Data Network (PDN) connection establishment request to the access network, using a control protocol, for each active PDN connection, in response to the prior TWAG being not reusable as the current TWAG. The apparatus 900 may optionally include an electrical component 970 for sending a Packet Data Network (PDN) connection establishment request to the access network, using a control protocol, for each active PDN connection. in response to: (a) the security information being not reusable, or (h) the addressing and routing configuration being not reusable,

In further related aspects, the apparatus 900 may optionally include a processor component 902. The processor 902 may be in operative communication with the components 910-970 via a bus 901 or similar communication coupling. The processor 902 may effect initiation and scheduling of the processes or functions performed by electrical components 910-970.

In yet further related aspects, the apparatus 900 may include a radio transceiver component 903. A standalone receiver and/or standalone transmitter may be used in lieu of or in conjunction with the transceiver 903. The apparatus 900 may optionally include a component for storing information, such as, for example, a memory device/component 904. The computer readable medium or the memory component 904 may be operatively coupled to the other components of the apparatus 900 via the bus 901 or the like. The memory component 904 may be adapted to store computer readable instructions and data for affecting the processes and behavior of the components 910-970, and subcomponents thereof, or the processor 902, or the methods disclosed herein. The memory component 904 may retain instructions for executing functions associated with the components 910-970. While shown as being external to the memory 904, it is to be understood that the components 910-970 cart exist within the memory 904. It is further noted that the components in FIG. 9 may comprise processors, electronic devices, hardware devices, electronic sub-components, logical circuits, memories, software codes, firmware codes, etc., or any combination thereof.

In accordance with one or more aspects of the implementations described herein, with reference to FIG. 10, there is shown an example methodology 1000 for gateway discovery and L2 mobility, operable by a network entity. The method 1000 may involve, at 1010, receiving an inquiry from an access terminal regarding whether a prior Trusted Wireless Access Gateway (TWAG) is reusable by the access terminal as a current TWAG. in an example aspect, the network entity includes the current TWAG.

The method 1000 may involve, at 1020, determining whether the prior TWAG is reusable.

The method 1000 may involve, at 1030, sending a response to the access terminal indicating whether the prior TWAG is reusable.

With continued reference to FIG. 10, there are also shown further operations or aspects that are optional and may be performed by a mobile device or component(s) thereof. The method 1000 may terminate after any of the shown blocks without necessarily having to include any subsequent downstream block(s) that may be illustrated. It is further noted that numbers of the blocks do not imply a particular order in which the blocks may be performed according to the method 1000.

The method 1000 may optionally involve, at 1040, receiving a Packet Data Network (PDN) connection estUblishment request from the access terminal.

The method 1000 may optionally involve, at 1050, determining whether a GPRS Tunneling Protocol (GTP) tunnel for the prior TWAG is to be moved to an address corresponding to the current TWAG.

The method 1000 may optionally involve, at 1060, sending a confirmation to the access terminal indicating that PDN establishment procedure is complete. In an example aspect, sending the confi: using a control protocol (e.g. WLCP or the like).

The method 1000 may optionally involve, at 1070, moving the GTP tunnel for the prior TWAG to the address corresponding to the current TWAG, in response to determining the GTP tunnel for the prior TWAG is to be moved.

In accordance with one or more aspects of the implementations described herein, FIG. 11 is a block diagram of an example apparatus 1100 for gateway discovery and L2 mobility. The exemplary apparatus 1100 may be configured as a network entity or as a processor or similar device/component for use within. In one example, the apparatus 1100 may include functional blocks that can represent functions implemented by a processor, software, or combination thereof (e.g,, firmware). In another example, the apparatus 1100 may be a system on a chip (SoC) or similar integrated circuit (IC).

In one implementation, apparatus 1100 may include an electrical component or module 1110 for receiving an inquiry from an access terminal regarding whether a prior Trusted Wireless Access Gateway (TWAG) is reusable by the access terminal as a current TW.AG. The apparatus 1100 may include an electrical component 1120 for determining whether the prior TWAG is reusable. The apparatus 1100 may include an electrical component 1130 for sending a response to the access terminal indicating whether the prior TWAG is reusable.

In further related aspects, the apparatus 1100 may optionally include an electrical component 1140 for receiving a PDN connection establishment request from the access terminal. The apparatus 1100 may optionally include an electrical component 1150 for determining whether a GPRS Tunneling Protocol (GTP) tunnel for the prior TWAG is to be moved to an address corresponding to the current TWAG. The apparatus 1100 may optionally include an electrical component 1160 for sending a confirmation to the access terminal indicating that PDN establishment procedure is complete. The apparatus 1100 may optionally include an electrical component 1170 for moving the GTP tunnel for the prior TWAG to the address corresponding to the current TWAG, in response to determining the GTP tunnel for the prior TWAG is to be moved.

For the sake of conciseness, the rest of the details regarding apparatus 1100 are not further elaborated on; however, it is to be understood that the remaining features and aspects of the apparatus 1100 are substantially similar to those described above with respect to apparatus 1000 of FIG. 10. Persons skilled in the art will appreciate that the functionalities of each component of apparatus 1100 can be implemented in any suitable component of the system or combined in any suitable manner.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their fimctionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The operations of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may he integral to the processor. The processor and the storage medium may reside in an ASIC. The ASIC may reside in a user terminal, In the alternative, the processor and the storage medium may reside as discrete components in a user terminal.

In one or more exemplary designs, the functions described may he implemented in hardware, software, firmware, or any combination thereof. If implemented in software, the functions may be stored on or transmitted over as one or more instructions or code on a non-transitory computer-readable medium. Non-transitory computer-readable media includes both computer storage media and communication media including any medium that facilitates transfer of a computer program from one place to another. A storage media may be any available media that can he accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blue ray disc where disks usually reproduce data magnetically, while discs reproduce data optically with lasers. Combinations of the above should also be included within the scope of non-transitory computer-readable media,

The previous description of the disclosure is provided to enable any person skilled in the art to make or use the disclosure. Various modifications to the disclosure will he readily apparent to those skilled in the art, and the generic principles defined herein may be applied to other variations without departing from the scope of the disclosure. Thus, the disclosure is not intended to be limited to the examples and designs described herein, but is to be accorded the widest scope consistent with the principles and novel features disclosed herein.

What is claimed is:

1. A method operable by an access terminal in a wireless communication network, comprising:
connecting to an access point;
determining security credentials and addressing and routing configurations used previously by the access terminal;
determining whether the security credentials may be reused by the access terminal to perform authentication with an access network; and
determining whether the addressing and routing configurations may be reused by the access terminal.

2. The method of claim 1, further comprising determining whether a prior Trusted Wireless Access Gateway (TWAG) may be reused by the access terminal as a current TWAG, in response to both the security credentials and the addressing and routing configurations being reusable.

3. The method of claim 2, further comprising sending a Packet Data Network (PDN) connection establishment request to the access network, using a control protocol, for each active PDN connection, in response to the prior TWAG being not reusable as the current TWAG.

4. The method of claim 3, wherein the PDN connection establishment request comprises a handover indication which indicates that the request is not for a new PDN connection.

5. The method of claim 2, wherein determining whether the prior TWAG may be reused comprises sending an inquiry to the access network.

6. The method of claim 5, wherein the inquiry comprises an address of the current TWAG.

7. The method of claim 5, wherein sending the inquiry comprises sending the inquiry through a broadcast Layer-2 access.

8. The method of claim 1, further comprising sending a Packet Data Network (PDN) connection establishment request to the access network, using a control protocol, for each active PDN connection, in response to at least one of: (a) the security information being not reusable, or (b) the addressing and routing configuration being not reusable.

9. The method of claim 8, wherein the PDN connection establishment request comprises a handover indication which indicates that the request is not for a new PDN connection.

10. The method of claim 1, wherein connecting to the access point comprises handing over to the access point from another access point.

11. The method of claim 1, wherein the access point is for a wireless local area network (WLAN).

12. The method of claim 1, wherein the access network comprises the current TWAG,

13. The method of claim 1, wherein the access network is connected to an Evolved Packet Core (EPC).

14. The method of claim 1, wherein the security credentials comprise at least one of encryption or authentication keys.

15. The method of claim 1, wherein determining whether the addressing and routing configurations may be reused comprises using a Detecting Network Attachment (DNA) procedure.

16. A wireless communication apparatus, comprising:
a radio frequency (RF) transceiver configured to connect to an access point; and
at least one processor configured to:
determine security credentials and addressing and routing configurations used previously by the apparatus;
determine whether the security credentials may be reused by the apparatus to perform authentication with an access network; and
determine whether the addressing and routing configurations may be reused by the apparatus.

17. The apparatus of claim 16, wherein the at least one processor is further configured to determine whether a prior Trusted Wireless Access Gateway (TWAG) may be reused by the apparatus as a current TWAG, in response to both the security credentials and the addressing and routing configurations being reusable.

18. The apparatus of claim 17, wherein the at least one processor is further configured to send a Packet Data Network (PDN) connection establishment request to the access network, using a control protocol, for each active PDN connection, in response to the prior TWAG being not reusable as the current TWAG.

19. The apparatus of claim 16, wherein the at least one processor is further configured to send a Packet Data Network (PDN) connection establishment request to the access network, using a control protocol, for each active PUN connection, in response to at least one of: (a) the security information being not reusable, or (b) the addressing and routing configuration being not reusable.

20. A wireless communication apparatus, comprising:
means for connecting to an access point;
means for determining security credentials and addressing and routing configurations used previously by the apparatus;
means for determining whether the security credentials may be reused by the apparatus to perform authentication with an access network; and
means for determining whether the addressing and routing configurations may be reused by the apparatus.

21. The apparatus of claim 20, further comprising means for determining whether a prior Trusted Wireless Access Gateway (TWAG) may be reused by the apparatus as a current TWAG, in response to both the security credentials and the addressing and routing configurations being reusable.

22. The apparatus of claim 21, further comprising means for sending a Packet Data Network (PDN) connection establishment request to the access network, using a control protocol, for each active PDN connection, in response to the prior TWAG being not reusable as the current TWAG.

23. The apparatus of claim 20, further comprising means for sending a Packet Data Network (PDN) connection establishment request to the access network, using a control protocol, for each active PDN connection, in response to at least one of: (a) the security information being not reusable, or (b) the addressing and routing configuration being not reusable.

24. A computer program product, comprising:
a non-transitory computer-readable medium comprising code for causing a computer to:
connect to an access point;
determine security credentials and addressing and routing configurations used previously by the computer;
determine whether the security credentials may be reused by the computer to perform authentication with an access network; and
determine whether the addressing and routing configurations may be reused by the computer.

25. The computer program product of claim 24, wherein the non-transitory computer-readable medium further comprises code for causing the computer to determine whether a prior Trusted Wireless Access Gateway (TWAG) may be reused by the computer as a current TWAG, in response to both the security credentials and the addressing and routing configurations being reusable.

26. The computer program product of claim 25, wherein the non-transitory computer-readable medium further comprises code for causing the computer to send a. Packet Data Network (PDN) connection establishment request to the access network, using a control protocol, for each active PDN connection, in response to the prior TWAG being not reusable as the current TWAG.

27. The computer program product of claim 24, wherein the non-transitory computer-readable medium further comprises code for causing the computer to send a Packet Data Network (PDN) connection establishment request to the access network, using a control protocol, for each active PDN connection, in response to at least one of: (a) the security information being not reusable, or (b) the addressing and routing configuration being not reusable.

28. A method operable by a network entity in a wireless communication network, comprising:
receiving an inquiry from an access terminal regarding whether a prior Trusted Wireless Access Gateway (TWAG) is reusable by the access terminal as a current TWAG;
determining whether the prior TWAG is reusable; and
sending a response to the access terminal indicating whether the prior TWAG is reusable.

29. The method of claim 28, wherein the network entity comprises the current TWAG.

30. The method of claim 28, further comprising:
receiving a Packet Data Network (PDN) connection establishment request from the access terminal; and
determining whether a GPRS Tunneling Protocol (GTP) tunnel for the prior TWAG is to be moved to an address corresponding to the current TWAG; and
sending a confirmation to the access terminal indicating that PDN establishment procedure is complete.

31. The method of claim 30, wherein sending the confirmation comprises using a control protocol.

32. The method of claim 30, further comprising moving the GTP tunnel for the prior TWAG to the address corresponding to the current TWAG, in response to determining the GTP tunnel for the prior TWAG is to be moved.

33. The method of claim 32, wherein moving the GTP tunnel comprises triggering handover of Packet Data Network (PDN) connections using GTP signaling towards a Packet Data Network Gateway (PDN-GW).

34. A wireless communication apparatus, comprising:
at least one processor configured to:
receive an inquiry from an access terminal regarding whether a prior Trusted Wireless Access Gateway (TWAG) is reusable by the access terminal as a current TWAG;
determine whether the prior TWAG is reusable; and
send a response to the access terminal indicating whether the prior TWAG is reusable.

35. The apparatus of claim 34, wherein the at least one processor is further configured to:
receive a Packet Data Network (PDN) connection establishment request from the access terminal; and
determine whether a GPRS Tunneling Protocol (GTP) tunnel for the prior TWAG is to be moved to an address corresponding to the current TWAG; and
send a confirmation to the access terminal indicating that PDN establishment procedure is complete.

36. The method of claim 35, wherein the at least one processor is further configured to move the GTP tunnel for the prior TWAG to the address corresponding to the current TWAG, in response to determining the GTP tunnel for the prior TWAG is to be moved.

37. A wireless communication apparatus, comprising:
means for receiving an inquiry from an access terminal regarding whether a prior Trusted Wireless Access Gateway (TWAG) is reusable as a current TWAG;
means for determining whether the prior TWAG is reusable; and
means for sending a response to the access terminal indicating whether the prior TWAG is reusable.

38. The apparatus of claim 37, wherein the network entity comprises the current TWAG.

39. The apparatus of claim 37, further comprising:
means for receiving a Packet Data Network (PDN) connection establishment request from the access terminal; and
means for determining whether a GPRS Tunneling Protocol (GTP) tunnel for the prior TWAG is to be moved to an address corresponding to the current TWAG; and
means for sending a confirmation to the access terminal indicating that PDN establishment procedure is complete,

40. The apparatus of claim 39, wherein means for sending the confirmation comprises means for using a control protocol.

41. The apparatus of claim 39, further comprising means for moving the GTP tunnel for the prior TWAG to the address corresponding to the current TWAG, in response to determining the GTP tunnel for the prior TWAG is to be moved.

42. The apparatus of claim 41, wherein means for moving the GTP tunnel comprises means for triggering handover of Packet Data Network (PDN) connections using GTP signaling towards a Packet Data Network Gateway (PDN-GW).

43. A computer program product, comprising:
a non-transitory computer-readable medium comprising code for causing a computer to:
receive an inquiry from an access terminal regarding whether a prior Trusted Wireless Access Gateway (TWAG) is reusable by the access terminal as a current TWAG;
determine whether the prior TWAG is reusable; and
send a response to the access terminal indicating whether the prior TWAG is reusable.

44. The computer program product of claim 43, wherein the non-transitory computer-readable medium further comprises code for causing the computer to:
receive a Packet Data Network (PDN) connection establishment request from the access terminal; and
determine whether a GPRS Tunneling Protocol (GTP) tunnel for the prior TWAG is to be moved to an address corresponding to the current TWAG; and
send a confirmation to the access terminal indicating that PDN establishment procedure is complete.

45. The computer program product of claim 44, wherein the non-transitory computer-readable medium further comprises code for causing the computer to move the GTP tunnel for the prior TWAG to the address corresponding to the current TWAG, in response to determining the GTP tunnel for the prior TWAG is to he moved.
